(19) United States
(12) Patent Application Publication
(10) Pub. No.: US 2026/0301635 A1
(43) Pub. Date: Oct. 1, 2026

(54) DETECTION METHOD CONFIGURED FOR DISPLAY DEVICE

(71) Applicant: Innolux Corporation, Miaoli County (TW)

(72) Inventors: Ming-Chi Weng, Miaoli County (TW); Cheng-Tso Hsiao, Miaoli County (TW); Ming-Chi Huang, Miaoli County (TW); Yu-Tse Lu, Miaoli County (TW)

(73) Assignee: Innolux Corporation, Miaoli County (TW)

(21) Appl. No.: 19/467,831

(22) Filed: Feb. 3, 2026

(30) Foreign Application Priority Data
Mar. 27, 2025 (CN) 202510375962.3

(51) Int. Cl. G09G 3/20; G09G 3/32

(52) U.S. Cl. CPC G09G 3/2007; G09G 3/32; G09G 2310/08

(57) ABSTRACT

Provided is a detection method configured for a display device. The display device includes multiple display units. The detection method includes: multiple data signals are respectively provided to corresponding display units of the multiple display units; a data signal corresponding to at least one of the multiple display units is selected to be replaced with a first specified data; a quantity of at least one specified display unit corresponding to the first specified data is less than a quantity of the multiple display units corresponding to the multiple data signals; and a first read signal of the at least one specified display unit is detected.

### CROSS-REFERENCE TO RELATED APPLICATION

This application claims the priority benefit of China application serial no. 202510375962.3, filed on Mar. 27, 2025. The entirety of the above-mentioned patent application is hereby incorporated by reference herein and made a part of this specification.

### BACKGROUND

### Technical Field

The disclosure relates to a detection method, and in particular relates to a detection method configured for a display device.

### Related Art

Generally, a display device may have a detection function to detect the display performance of multiple sub-pixels of the display device to generate a detection result. The display device may compensate the display performance of the display device according to the detection result. In order to detect the display performance of all sub-pixels of the display device, it takes a considerable amount of time for the display device to detect all grayscale results of all sub-pixels. However, during the detection of all grayscale results of all sub-pixels, the display device may not display the frame that the user wants to view. Therefore, the display device may only execute the detection function during power-on, or set to execute the detection function after each long time period (such as 4 hours). It can be seen that the display device cannot execute the existing detection function in real time.

### SUMMARY

The disclosure is a detection method configured for a display device. The detection method can be executed in real time.

In an embodiment of the disclosure, a detection method is configured for a display device. The display device includes multiple display units and a substrate. The multiple display units are on the substrate. The detection method includes: multiple data signals are provided to corresponding display units of the plurality of display units; a data signal corresponding to at least one of the multiple display units is selected to be replaced with a first specified data; a quantity of at least one specified display unit corresponding to the first specified data is less than a quantity of the multiple display units corresponding to the multiple data signals; and a first read signal of the at least one specified display unit is detected.

Based on the above, the quantity of the at least one specified display unit corresponding to the first specified data is less than the quantity of the multiple display units. Therefore, in dynamic display, it is difficult for the user to detect the detection frame displayed by the at least one specified display unit. In this way, the detection method of the disclosure can be executed in real time.

### BRIEF DESCRIPTION OF THE DRAWINGS

FIG. 1 is a schematic diagram of a display device according to an embodiment of the disclosure.

FIG. 2 is a flow chart of a detection method according to an embodiment of the disclosure.

FIG. 3 is a flow chart of operations according to an embodiment of the disclosure.

FIG. 4 is a timing diagram of operations according to an embodiment of the disclosure.

FIG. 5 is a circuit diagram of a display unit according to an embodiment of the disclosure.

FIG. 6 is a timing diagram of operations according to an embodiment of the disclosure.

FIG. 7 is a timing diagram of operations according to an embodiment of the disclosure.

FIG. 8 is a schematic diagram of operations according to an embodiment of the disclosure.

FIG. 9 is a schematic diagram of operations according to an embodiment of the disclosure.

FIG. 10 is a schematic diagram of a controller according to an embodiment of the disclosure.

### DESCRIPTION OF THE EMBODIMENTS

The disclosure may be understood by referring to the following detailed description taken in conjunction with the accompanying drawings as described below. It should be noted that, for purposes of clarity and easy understanding by readers, each drawing of the disclosure depicts a portion of an electronic device, and some elements in each drawing may not be drawn to scale. In addition, the number and size of each device depicted in the drawings are illustrative and not intended to limit the scope of the disclosure.

Note that technical features in different embodiments described below may be replaced, recombined, or mixed with each other to form another embodiment without departing from the spirit of the disclosure.

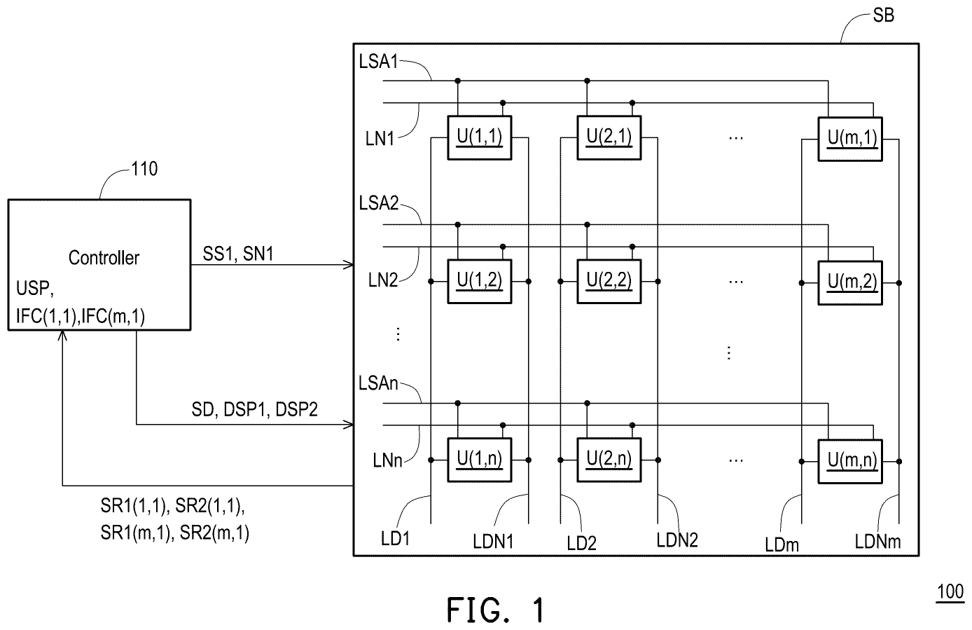

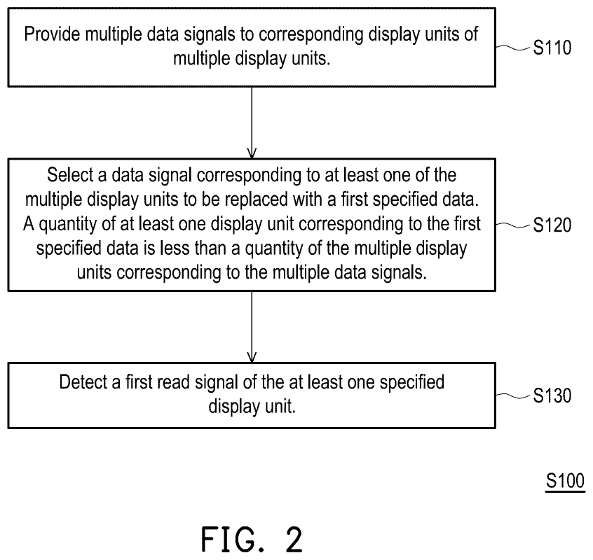

Please refer to FIG. 1 and FIG. 2. FIG. 1 is a schematic diagram of a display device according to an embodiment of the disclosure. FIG. 2 is a flow chart of a detection method according to an embodiment of the disclosure. In the embodiment, a display device 100 includes display units U(1,1) to U(m,n) and a substrate SB. The display units U(1,1) to U(m,n) are disposed on the substrate SB. For example, the display units U(1,1) to U(m,1) are located in a first pixel row. The display units U(1,2) to U(m,2) are located in a second pixel row. Likewise, the display units U(1,n) to U(m,n) are located in an nth pixel row. The display units U(1,1) to U(1,n) are located in a first pixel column. The display units U(2,1) to U(2,n) are located in a second pixel column. Likewise, the display units U(m,1) to U(m,n) are located in an mth pixel column.

In the embodiment, the display device 100 may execute a detection method S100. The display device 100 further includes a controller 110. The detection method S100 includes steps S110 to S130. In step S110, the display device 100 respectively provides a data signal SD to a corresponding display unit of the display units U(1,1) to U(m,n). Therefore, in step S110, the display device 100 may normally display the frame that the user wants to view.

In step S120, the controller 110 selects the data signal SD corresponding to at least one of the display units U(1,1) to U(m,n) to be replaced with a first specified data DSP1. In the embodiment, a quantity of at least one specified display unit USP corresponding to the first specified data DSP1 is less than a quantity of the display units U(1,1) to U(m,n). Therefore, in step S120, display units other than the at least one specified display unit USP may also normally display the frame that the user wants to view. In step S130, the controller 110 detects a first read signal SR1(1,1) of the at least one specified display unit USP.

For example, in the embodiment, in step S120, the controller 110 selects the display unit U(1,1) as the specified display unit USP. Based on a scan signal SS1 located at a scan line LSA1, the first specified data DSP1 may be provided to the display unit U(1,1) through a data line LD1. Therefore, the display unit U(1,1) provides a display result corresponding to the first specified data DSP1. The display units U(1,2) to U(m,n) other than the display unit U(1,1) may continue to normally display the frame that the user wants to view. In step S130, based on a detection signal SN1 located at a detection scan line LN1, the controller 110 receives the first read signal SR1(1,1) from the display unit U(1,1) through a detection data line LDN1, and detects the first read signal SR1(1,1). A period of detecting the first read signal SR1(1,1) is later than a period of the display unit U(1,1) receiving the first specified data DSP1.

It is worth mentioning here that the quantity of the specified display unit USP corresponding to the first specified data DSP1 is less than the quantity of the display units U(1,1) to U(m,n). Therefore, in dynamic display, it is difficult for the user to detect the detection frame displayed by the specified display unit USP. In this way, the detection method of the disclosure can be executed in real time.

In the embodiment, the controller 110 selects the data signal SD corresponding to the specified display unit USP to be replaced with a second specified data DSP2. The second specified data DSP2 is written to the display unit U(1,1). Therefore, the display unit U(1,1) provides a display result corresponding to the specified data DSP2. The display units U(1,2) to U(m,n) other than the display unit U(1,1) may continue to normally display the frame that the user wants to view. In step S130, the controller 110 receives a second read signal SR2(1,1) from the display unit U(1,1) through the detection data line LDN1, and detects the second read signal SR2(1,1).

In the embodiment, a write-in time of the first specified data DSP1 is earlier than a write-in time of the second specified data DSP2. For example, the write-in time of the first specified data DSP1 is earlier than the write-in time of the second specified data DSP2 by at least one frame time. In other words, in timing, the write-in time of the first specified data DSP1 and the write-in time of the second specified data DSP2 are separated by at least one frame time.

In the embodiment, the first specified data DSP1 corresponds to a first specified grayscale value. The second specified data DSP2 corresponds to a second specified grayscale value. The second specified grayscale value is different from the first specified grayscale value. For example, the second specified grayscale value is higher than the first specified grayscale value. Therefore, the first read signal SR1(1,1) and the second read signal SR2(1,1) from the display unit U(1,1) correspond to electrical results of different grayscales.

In the embodiment, the controller 110 may calculate compensation information IFC(1,1) according to the first read signal SR1(1,1) and the second read signal SR2(1,1). For example, the controller 110 may determine whether the electrical performance of the display unit U(1,1) has an offset according to the compensation information IFC(1,1). It should be understood that when the electrical performance of the display unit U(1,1) is determined to have an offset, the display performance of the display unit U(1,1) may also have an offset. Therefore, the controller 110 may utilize the compensation information IFC(1,1) to compensate the data corresponding to the display unit U(1,1), thereby correcting the offset of the electrical performance of the display unit U(1,1).

In some embodiments, the quantity of the specified display units USP may be multiple. For another example, in step S120, the controller 110, for example, selects the display units U(1,1) and U(m,1) as the specified display units USP. The first specified data DSP1 is provided to the display units U(1,1) and U(m,1). Therefore, the display units U(1,1) and U(m,1) respectively provide display results corresponding to the first specified data DSP1. Other display units other than the display units U(1,1) and U(m,1) may continue to normally display the frame that the user wants to view. In step S130, the controller 110 receives the first read signal SR1(1,1) from the display unit U(1,1) through the detection data line LDN1, receives a first read signal SR1(m,1) from a display unit U(m,1) through a detection data line LDNm, and detects the first read signals SR1(1,1) and SR1(m,1).

In addition, the display units U(1,1) and U(m,1) respectively provide display results corresponding to the second specified data DSP2. Other display units other than the display units U(1,1) and U(m,1) may continue to normally display the frame that the user wants to view. In step S130, the controller 110 receives the second read signal SR2(1,1) from the display unit U(1,1) through the detection data line LDN1, receives a second read signal SR2(m,1) from the display unit U(m,1) through the detection data line LDNm, and detects the second read signals SR2(1,1) and SR2(m,1).

The controller 110 may calculate the compensation information IFC(1,1) according to the first read signal SR1(1,1) and the second read signal SR2(1,1), and calculate compensation information IFC(m,1) according to the first read signal SR1(m,1) and the second read signal SR2(m,1). The controller 110 may utilize the compensation information IFC(1,1) to compensate the data corresponding to the display unit U(1,1), thereby correcting the offset of the electrical performance of the display unit U(1,1). The controller 110 may utilize the compensation information IFC(m,1) to compensate the data corresponding to the display unit U(m,1), thereby correcting the offset of the electrical performance of the display unit U(m,1).

In the embodiment, the display device 100 may be a self-luminous unit. For example, the display device 100 may be any type of LED display. For example, the display device 100 may be a backlight module of a liquid crystal display.

In the embodiment, the quantity of the specified display units USP is significantly less than the quantity of the display units U(1,1) to U(m,n), thereby making it difficult for the user to detect the detection frame displayed by the specified display units USP. For example, the quantity of the specified display units USP is less than 15% of the quantity of the display units U(1,1) to U(m,n).

In an embodiment, the controller 110 may be disposed on the substrate SB. In an embodiment, the controller 110 may be disposed outside the substrate SB.

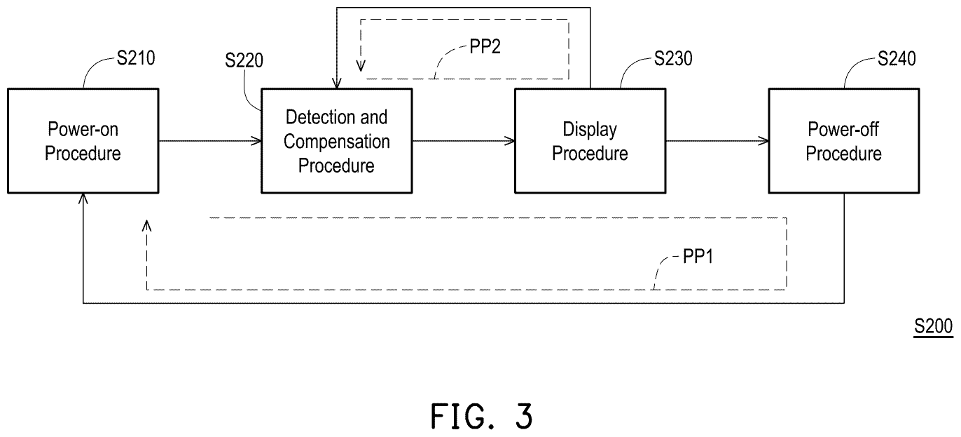

Please refer to FIG. 1, FIG. 2 and FIG. 3. FIG. 3 is a flow chart of operations according to an embodiment of the disclosure. FIG. 3 shows an operation process S200. In the embodiment, the operation process S200 includes processes S210 to S240. Process S210 is a power-on procedure. Process S220 is a detection and compensation procedure. Process S230 is a display procedure. Process S240 is a power-off procedure. Regarding an existing operation method, the existing operation method is executed based on a process path PP1. That is to say, the existing operation method executes process S220 after the power-on procedure, and executes process S230 after the detection of all display units is completed. In the embodiment, the operation method S100 alternately or simultaneously executes process S220 and process S230, as shown in a process path PP2. Therefore, when the frame is normally displayed, the display device 100 can execute the operation method S100 in real-time.

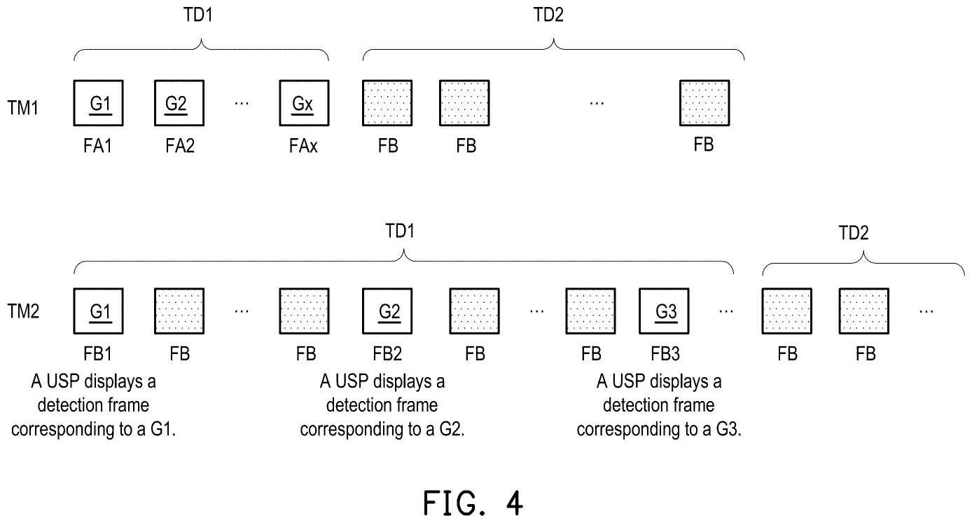

Further explaining in terms of timing, please refer to FIG. 1 and FIG. 4. FIG. 4 is a timing diagram of operations according to an embodiment of the disclosure. FIG. 4 shows a timing TM1 of the existing operation method and a timing TM2 of the operation method of the embodiment. In the timing TM1, multiple specified data corresponding to different specified grayscale values G1 to Gx are sequentially written to all display units during a detection period TD1. For example, in the timing TM1, the specified grayscale values G1 to Gx are sequentially incremented. Therefore, during the detection period TD1 of the timing TM1, an entire frame of the display device 100 converts, for example, from dark to bright. During frame times FA1 to FAx of the detection period TD1, the frame that the user wants to view may not be displayed. During a display period TD2, the frame that the user wants to view may be displayed.

In the embodiment, during the detection period TD1 of the timing TM2, in a frame time FB1, a specified display unit USP displays a detection frame corresponding to the specified grayscale value G1. Other display units other than the specified display unit USP normally display the frame that the user wants to view. It should be noted that a quantity of the specified display unit USP is significantly less than the quantity of the display units U(1,1) to U(m,n). It is difficult for the user to detect the detection frame displayed by the specified display unit USP. Therefore, in the frame time FB1, the display device 100 displays the frame that the user wants to view.

In a frame time FB2 of the timing TM2, a specified display unit USP displays a detection frame corresponding to a specified grayscale value G2. In a frame time FB3 of the timing TM2, a specified display unit USP displays a detection frame corresponding to a specified grayscale value G3, and so on. The frame time FB2 and the frame time FB1 are separated by at least one frame time FB. The frame time FB3 and the frame time FB2 are separated by at least one frame time FB. In the frame time FB, the display units U(1,1) to U(m,n) do not display the detection frame. Therefore, the display device 100 decreases the quantity of the specified display units USP and extends the timing of the detection time to reduce the perceptibility of the detection frame to the human eyes. The visual performance of the detection frame of the specified display units USP is not significant. In this way, during a period when the frame that the user wants to view is displayed, the display device 100 can execute the detection of the specified display units USP in real-time.

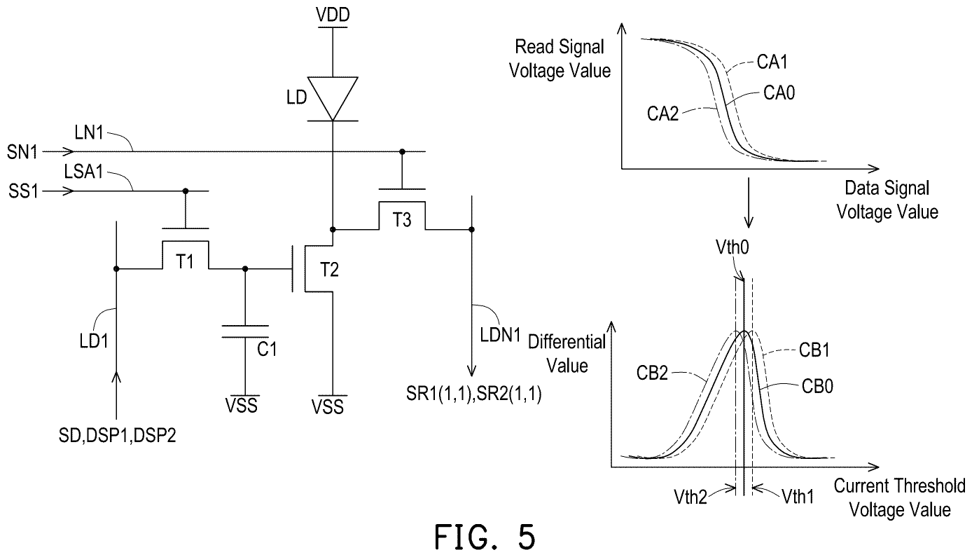

Please refer to FIG. 1 and FIG. 5. FIG. 5 is a circuit diagram of a display unit according to an embodiment of the disclosure. In the embodiment, the display unit U(1,1) includes transistors T1, T2 and T3, a light emitting element LD, and a capacitor C1. An anode of the light emitting element LD is connected to a reference high voltage VDD. A first end of the transistor T2 is connected to a cathode of the light emitting element LD. A second end of the transistor T2 is connected to a reference low voltage VSS. A first end of the transistor T1 is connected to the data line LD1. A second end of the transistor T1 is connected to a control end of the transistor T2. A control end of the transistor T1 is connected to a scan line LSA1. A first end of the transistor T3 is connected to the cathode of the light emitting element LD. A second end of the transistor T3 is connected to the detection data line LDN1. A control end of the transistor T3 is connected to the detection scan line LN1. The capacitor C1 is connected between the control end of the transistor T2 and the reference low voltage VSS.

In the embodiment, take the display unit U(1,1) being selected as the specified display unit USP as an example. In one frame time, the transistor T1 is turned on in response to a pulse of the scan signal SS1 located at the scan line LSA1. Therefore, the first specified data DSP1 is provided to the control end of the transistor T2. The transistor T2 may drive the light emitting element LD based on the first specified data DSP1. The transistor T3 is turned on in response to a pulse of the detection signal SN1 located at the detection scan line LN1. Therefore, the first read signal SR1(1,1) located at the cathode of the light emitting element LD is output to the detection data line LDN1. It can be seen that the first read signal SR1(1,1) is an electrode signal of the specified display unit USP.

In another frame time, the transistor T1 is turned on in response to a pulse of the scan signal SS1. The second specified data DSP2 is provided to the control end of the transistor T2. The transistor T2 may drive the light emitting element LD based on the second specified data DSP2. The transistor T3 is turned on in response to a pulse of the detection signal SN1. Therefore, the second read signal SR2(1,1) located at the cathode of the light emitting element LD is output to the detection data line LDN1. The second read signal SR2(1,1) is an electrode signal of the specified display unit USP.

The controller 110 receives the first read signal SR1(1,1) and the second read signal SR2(1,1), and obtains a first voltage difference between the first read signal SR1(1,1) and the second read signal SR2(1,1). When the first voltage difference between the first read signal SR1(1,1) and the second read signal SR2(1,1) has a maximum slope relative to a second voltage difference between the first specified data DSP1 and the second specified data DSP2, the controller 110 obtains a current threshold voltage value of the transistor T2. That is to say, the controller 110 performs a differentiation of the first voltage difference by the second voltage difference to obtain a maximum differential value, and sets a read signal corresponding to the maximum differential value to be equal to the current threshold voltage value.

If the current threshold voltage value of the transistor T2 is different from an initial threshold voltage value Vth0 of the transistor T2, the controller 110 generates the compensation information IFC(1,1) according to a difference between the current threshold voltage value and the initial threshold voltage value Vth0, thereby correcting the offset of the electrical performance of the display unit U(1,1).

In the embodiment, the light emitting element LD may be implemented by any type of light emitting diode.

In the embodiment, after multiple read signals are collected, one of relationship curves CA1 and CA2 between a specified data (including the first specified data DSP1 and the second specified data DSP2) and read signals (including the first read signal SR1(1,1) and the second read signal SR2(1,1)) is generated. Compared to an initial relationship curve CA0 of the transistor T2, the relationship curve CA1 is shifted to the right. The relationship curve CA2 is shifted to the left. Therefore, after differential computation, the relationship curve CA1 is converted to a differential curve CB1. The relationship curve CA2 is converted to a differential curve CB2. Compared to an initial differential curve CB0 of the transistor T2, the differential curve CB1 is shifted to the right. Therefore, the differential curve CB1 indicates that a threshold voltage value Vth1 (that is, the current threshold voltage value) corresponding to the maximum differential value is greater than the initial threshold voltage value Vth0. The differential curve CB2 is shifted to the left. Therefore, the differential curve CB2 indicates that a threshold voltage value Vth2 (that is, the current threshold voltage value) corresponding to the maximum differential value is less than the initial threshold voltage value Vth0.

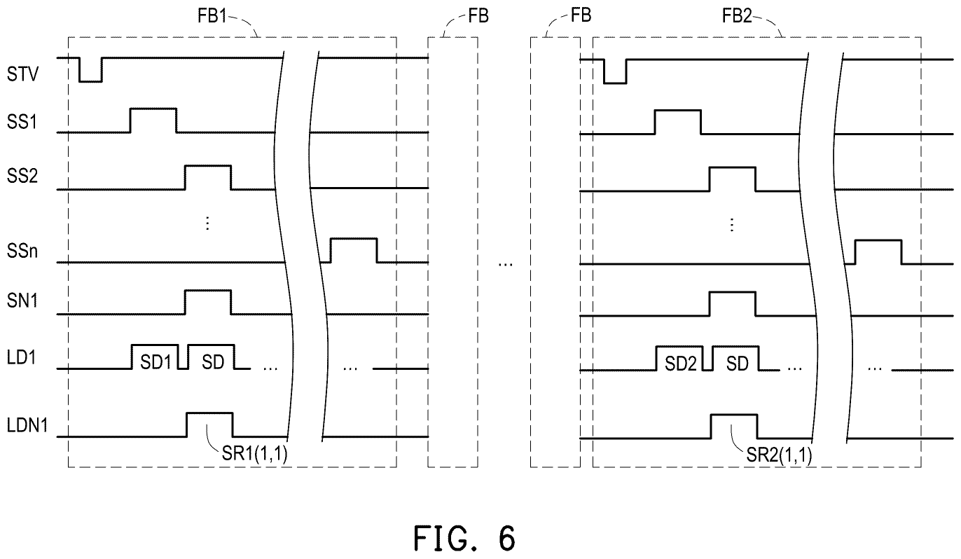

Refer to FIG. 1, FIG. 5 and FIG. 6. FIG. 6 is a timing diagram of operations according to an embodiment of the disclosure. In the embodiment, take the display unit U(1,1) being selected as the specified display unit USP as an example. In the frame time FB1, pulses of the scan signals SS1 to SSn are sequentially generated based on an initial signal STV. During the period when the scan signal SS1 has a pulse, the display unit U(1,1) receives the first specified data DSP1 from the data line LD1. During the period when the detection signal SN1 located at the detection scan line LN1 has a pulse, the display unit U(1,1) outputs the first read signal SR1(1,1). For example, a timing of the detection signal SN1 is similar to a timing of the scan signal SS2. During the period when the scan signals SS2 to SSn have pulses, the data signal SD located at the data line LD1 is configured to normally display the frame that the user wants to view.

In at least one frame time FB after the frame time FB1, there is the data signal SD on the data line LD1.

In the frame time FB2 after at least one frame time FB, during the period when the scan signal SS1 has a pulse, the display unit U(1,1) receives the second specified data DSP2 from the data line LD1. During the period when the detection signal SN1 located at the detection scan line LN1 has a pulse, the display unit U(1,1) outputs the second read signal SR2(1,1). During the period when the scan signals SS2 to SSn have pulses, the data signal SD located at the data line LD1 is configured to normally display the frame that the user wants to view.

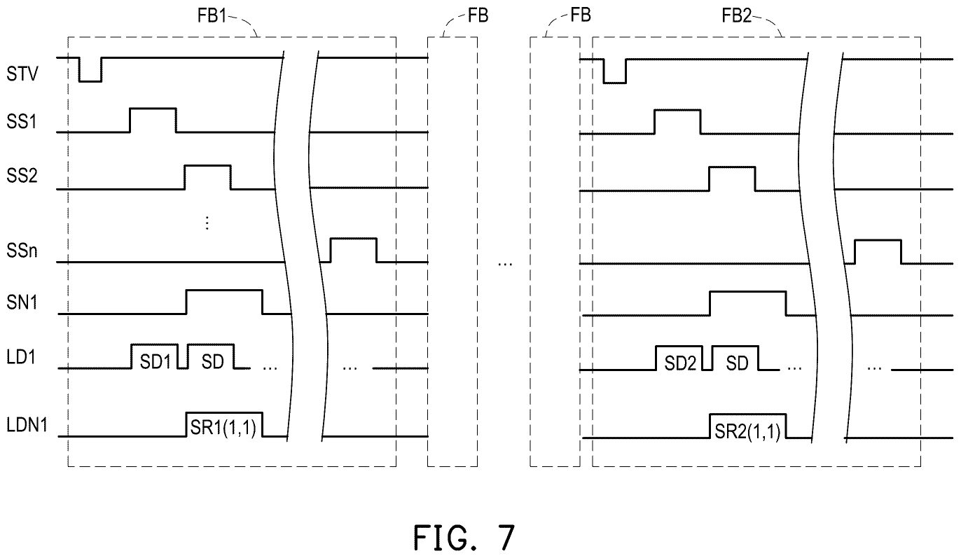

Refer to FIG. 1, FIG. 5 and FIG. 7. FIG. 7 is a timing diagram of operations according to an embodiment of the disclosure. In the embodiment, similarly take the display unit U(1,1) being selected as the specified display unit USP as an example. Different from FIG. 6, in the frame time FB1, the detection signal SN1 has a wider pulse. A pulse width of the detection signal SN1 is greater than a pulse width of the scan signal SS2. In the embodiment, the pulse width of the detection signal SN1 may be increased based on an electrical delay (RC delay) on the substrate SB, thereby allowing the display unit U(1,1) to output the correct first read signal SR1(1,1).

Similarly, in the frame time FB2, the detection signal SN1 has a wider pulse.

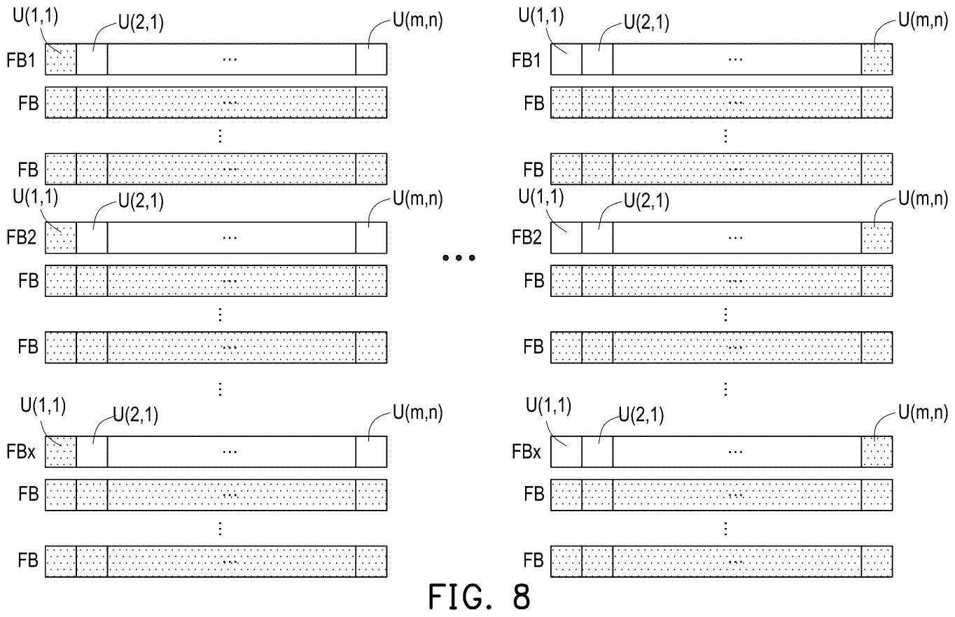

Refer to FIG. 1 and FIG. 8. FIG. 8 is a schematic diagram of operations according to an embodiment of the disclosure. In the embodiment, for ease of description, FIG. 8 represents the display units U(1,1) to U(m,n) of FIG. 1 in a single column arrangement manner.

First, the display unit U(1,1) is selected as the specified display unit USP. In the frame time FB1, the display unit U(1,1) is driven according to the first specified data DSP1 and outputs the first read signal SR1(1,1). In the frame time FB2 after k frame times FB, the display unit U(1,1) is driven according to the second specified data DSP2 and outputs the second read signal SR2(1,1). Likewise, in a frame time FBx, the display unit U(1,1) is driven according to an xth specified data and outputs an xth read signal SRx(1,1).

Next, the display unit U(1,2) is selected as the specified display unit USP. In the frame time FB1, the display unit U(1,2) is driven according to the first specified data DSP1 and outputs the first read signal SR1(1,2). In the frame time FB2 after k frame times FB, the display unit U(1,2) is driven according to the second specified data DSP2 and outputs the second read signal SR2(1,2). Likewise, in a frame time FBx, the display unit U(1,2) is driven according to an xth specified data and outputs an xth read signal SRx(1,2).

Likewise, the display unit U(m,n) is selected as the specified display unit USP. In the frame time FB1, the display unit U(m,n) is driven according to the first specified data DSP1 and outputs the first read signal SR1(m,n). In the frame time FB2 after k frame times FB, the display unit U(m,n) is driven according to the second specified data DSP2 and outputs the second read signal SR2(m,n). Likewise, in a frame time FBx, the display unit U(m,n) is driven according to an xth specified data and outputs an xth read signal SRx(m,n).

For example, there are a total of 1405 display units U(1,1) to U(m,n) (though the disclosure is not limited thereto). A number of grayscales configured for detection is 20. k is equal to 9. A frame frequency is equal to 240 Hz. A frame time is equal to 4.167 milliseconds. Therefore, an overall detection time length is 19 minutes and 30.27 seconds (that is, a quantity of display units×number of grayscales×(k+1)×4.167 milliseconds).

It should be noted that, although the foregoing operation takes 19 minutes and 30.27 seconds. However, during the process, the display device 100 may normally display the frame that the user wants to view. It is difficult for the user to detect the detection frame displayed by the specified display unit USP.

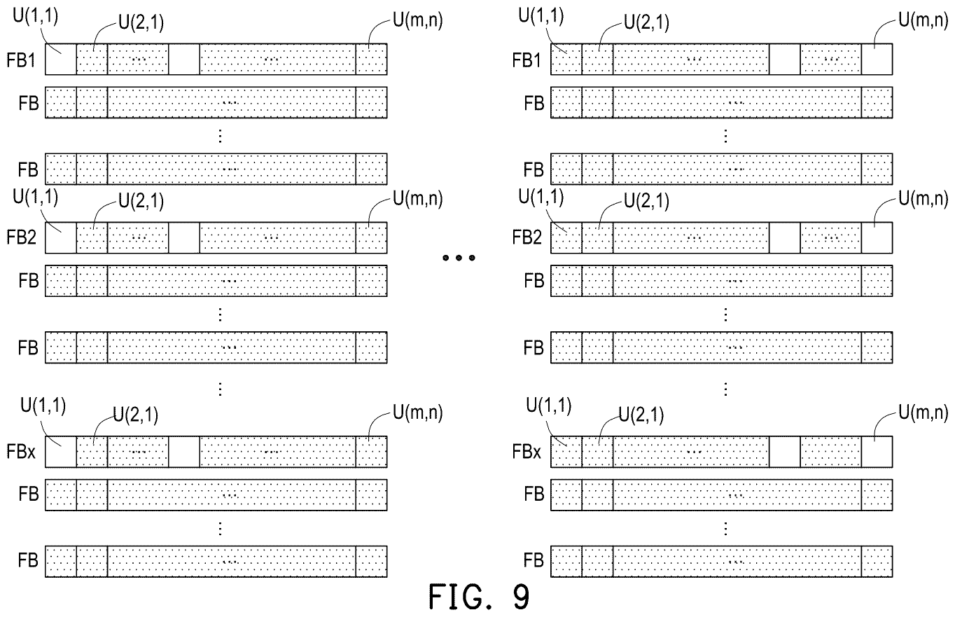

Please refer to FIG. 1 and FIG. 9. FIG. 9 is a schematic diagram of operations according to an embodiment of the disclosure. For ease of description, FIG. 9 represents the display units U(1,1) to U(m,n) of FIG. 1 in a single row arrangement manner. The embodiment may be adapted to the display device 100 with a high resolution. Compared with FIG. 8, the embodiment takes at least two display units to serve as the specified display unit USP, thereby shortening the overall detection time. Take the display device 100 with 1920×RGB×1080 as an example. In each of the frame times FB1 to FBx of a first period, 10000 non-adjacent display units are selected to serve as the specified display units USP in the embodiment. In each of the frame times FB1 to FBx of a second period, another 10000 non-adjacent display units are selected to serve as the specified display units USP in the embodiment. Therefore, the display units U(1,1) to U(m,n) are divided into a total of approximately 622 sets. In addition, a number of grayscales configured for detection is 20. k is equal to 9. A frame frequency is equal to 60 Hz. A frame time is equal to 16.67 milliseconds. Therefore, an overall detection time length is 34 minutes and 33.748 seconds (that is, 622×number of grayscales×(k+1)×16.67 milliseconds).

When a quantity of the specified display units USP is smaller, a detection time length is longer. When the quantity of the specified display units USP is larger, the detection time length is shorter. However, in order to make it difficult for the user to detect the detection frame displayed by the specified display units USP, in each of the frame times FB1 to FBx, the quantity of the specified display units USP is less than 15% of the quantity of the display units U(1,1) to U(m,n).

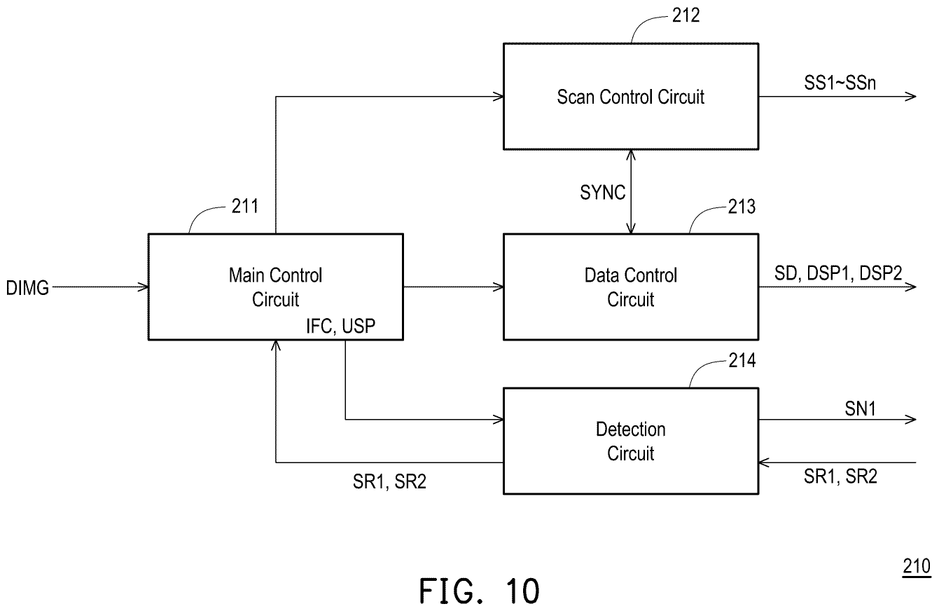

Please refer to FIG. 1 and FIG. 10. FIG. 10 is a schematic diagram of a controller according to an embodiment of the disclosure. In the embodiment, a controller 210 includes a main control circuit 211, a scan control circuit 212, a data control circuit 213, and a detection circuit 214. The main control circuit 211 receives an image data DIMG. The main control circuit 211 is connected to the scan control circuit 212, the data control circuit 213, and the detection circuit 214. The main control circuit 211 controls the scan control circuit 212, the data control circuit 213, and the detection circuit 214. For example, the main control circuit 211 provides an initialization signal and/or an internal clock. The scan control circuit 212 may provide scan signals SS1 to SSn according to the initialization signal and/or the internal clock.

The main control circuit 211 controls the data control circuit 213 according to the image data DIMG. Therefore, the data control circuit 213 may output a data signal SD corresponding to the image data DIMG. In addition, the data control circuit 213 may communicate with the scan control circuit 212 through a synchronization signal SYNC, thereby ensuring that a timing between the data control circuit 213 and the scan control circuit 212 may match each other.

In the embodiment, the controller 210 may control the display units U(1,1) to U(m,n) to display an image according to the image data DIMG. When the main control circuit 211 does not receive a detection command, the display units U(1,1) to U(m,n) continuously display the image corresponding to the image data DIMG.

When the main control circuit 211 receives a detection command, the main control circuit 211 may select at least one of the display units U(1,1) to U(m,n) to serve as the specified display unit USP. Therefore, the data signal SD of the data control circuit 213 corresponding to the specified display unit USP is replaced with the first specified data DSP1. The detection circuit 214 provides the detection signal SN1 based on a selection of the main control circuit 211 and receives a first read signal SR1 from the display unit USP.

The data signal of the data control circuit 213 corresponding to the specified display unit USP is replaced with the second specified data DSP2. The detection circuit 214 provides the detection signal SN1 based on a selection of the main control circuit 211 and receives a second read signal SR2 from the display unit USP.

In addition, the main control circuit 211 receives the first read signal SR1 and the second read signal SR2 and records the first read signal SR1 and the second read signal SR2. The main control circuit 211 calculates the compensation information IFC according to the first read signal SR1 and the second read signal SR2. The main control circuit 211 utilizes the compensation information IFC to adjust the data signal SD, thereby correcting an offset of the electrical performance of the display units U(1,1) to U(m,n). The main control circuit 211 may obtain the compensation information IFC according to the operation method as shown in FIG. 5.

In the embodiment, the scan control circuit 212 may be implemented by a gate drive circuit. The data control circuit 213 may be implemented by a source drive circuit. The main control circuit 211 may be implemented by a timing controller or a similar circuit.

In an embodiment, the controller 210 may be disposed on the substrate SB. In an embodiment, the controller 210 may be disposed outside the substrate SB. In an embodiment, the scan control circuit 212, the data control circuit 213, and the detection circuit 214 may be disposed on the substrate SB. In addition, the main control circuit 211 is disposed outside the substrate SB.

What is claimed is:

1. A detection method configured for a display device, wherein the display device comprises a plurality of display units and a substrate, the plurality of display units are on the substrate, and the detection method comprises:
providing a plurality of data signals to corresponding display units of the plurality of display units;
selecting a data signal corresponding to at least one of the plurality of display units to be replaced with a first specified data, wherein a quantity of at least one specified display unit corresponding to the first specified data is less than a quantity of the plurality of display units corresponding to the plurality of data signals; and
detecting a first read signal of the at least one specified display unit.

2. The detection method according to claim 1, wherein the display device is a self-luminous unit.

3. The detection method according to claim 1, wherein the quantity of the at least one specified display unit is less than 15% of the quantity of the plurality of display units.

4. The detection method according to claim 1, wherein the first read signal is an electrode signal of the at least one specified display unit.

5. The detection method according to claim 1, wherein one of the plurality of display units comprises:
a light emitting element, wherein a first end of the light emitting element is connected to a first reference voltage;
a first transistor, wherein a first end of the first transistor is connected to a data line, and a control end of the first transistor receives a scan signal;
a second transistor, wherein a first end of the second transistor is connected to a second end of the light emitting element, a second end of the second transistor is connected to a second reference voltage, and a control end of the second transistor is connected to a second end of the first transistor; and
a third transistor, wherein a first end of the third transistor is connected to the second end of the light emitting element, a second end of the third transistor is connected to a detection data line, and a control end of the third transistor receives a detection signal.

6. The detection method according to claim 5, further comprising:
outputting the first read signal to the detection data line in response to a pulse of the detection signal.

7. The detection method according to claim 5, wherein a pulse width of the detection signal is equal to a pulse width of the scan signal.

8. The detection method according to claim 5, wherein a pulse width of the detection signal is greater than a pulse width of the scan signal.

9. The detection method according to claim 5, wherein the one of the plurality of display units further comprises:
a capacitor, connected between the control end of the second transistor and the second reference voltage.

10. The detection method according to claim 1, wherein the detection method further comprises:
writing a second specified data to the at least one specified display unit; and
detecting a second read signal of the at least one specified display unit.

11. The detection method according to claim 10, wherein the detection method further comprises:
calculating compensation information according to the first read signal and the second read signal.

12. The detection method according to claim 11, wherein the steps of calculating the compensation information according to the first read signal and the second read signal comprise:
obtaining a first voltage difference between the first read signal and the second read signal;
obtaining a current threshold voltage value of the at least one specified display unit when the first voltage difference has a maximum slope relative to a second voltage difference between the first specified data and the second specified data; and
calculating the compensation information according to the current threshold voltage value.

13. The detection method according to claim 12, wherein the steps of calculating the compensation information according to the current threshold voltage value further comprise:
performing a differentiation of the first voltage difference by the second voltage difference to obtain a maximum differential value, and setting a read signal corresponding to the maximum differential value to be equal to the current threshold voltage value.

14. The detection method according to claim 12, wherein the steps of calculating the compensation information according to the current threshold voltage value comprise:
calculating the compensation information according to the current threshold voltage value and an initial threshold voltage value.

15. The detection method according to claim 14, wherein the steps of calculating the compensation information according to the current threshold voltage value and the initial threshold voltage value comprise:
generating the compensation information according to a difference between the current threshold voltage value and the initial threshold voltage value when the current threshold voltage value is different from the initial threshold voltage value.

16. The detection method according to claim 10, wherein a write-in time of the first specified data is earlier than a write-in time of the second specified data.

17. The detection method according to claim 10, wherein a write-in time of the first specified data is earlier than a write-in time of the second specified data by at least one frame time.

18. The detection method according to claim 10, wherein:
the first specified data corresponds to a first specified grayscale value,
the second specified data corresponds to a second specified grayscale value, and
the second specified grayscale value is different from the first specified grayscale value.

19. The detection method according to claim 18, wherein the second specified grayscale value is higher than the first specified grayscale value.

20. The detection method according to claim 1, wherein the at least one specified display unit is not adjacent to each other.
